(19) United States
(12) Patent Application Publication
(10) Pub. No.: US 2006/0113887 A1
(43) Pub. Date: Jun. 1, 2006

(54) Fluorescent lamp

(75) Inventor: Shi Youl Noh, Kyonggi-do (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: Feelux Co., Ltd.

(21) Appl. No.: 10/775,378

(22) Filed: Nov. 26, 2004

(51) Int. Cl. H01J 1/62; H01J 63/04

(52) U.S. Cl. 313/493

(57) ABSTRACT

Disclosed is a fluorescent lamp, which can remove an irregular arrangement of fluorescent lamp holders and prevent break-off of illumination generated at spaces formed between connected fluorescent lamps when the fluorescent lamp holders are arranged in series. The fluorescent lamp includes a tubular lamp body (21); auxiliary tubes (23) extending from both side ends of the tubular lamp body (21); and connection terminals (22) formed inwardly at both side ends of the auxiliary tubes (23). A variety of fluorescent lamp holders for allowing the use of the fluorescent lamp are provided.

### BACKGROUND OF THE INVENTION

1. Field of the Invention

The present invention relates to an improved fluorescent lamp, and more particularly, to a fluorescent lamp, which can prevent break-off of illumination at connection parts when several fluorescent lamps are connected to each other.

2. Background of the Related Art

As shown in FIG. 1, a fluorescent lamp 1, which has been used till now, has connection terminals 2 mounted at both ends thereof. Such a fluorescent lamp 1 is installed on a fluorescent lamp holder 10 to light up.

Recently, fluorescent lamps serve as not only a light for lighting up but also a decoration for a visual effect by installing it in a showcase or a showroom of a shop, and so, slim profile fluorescent lamps of a small sectional area are used to minimize an occupation area of the fluorescent lamps.

Furthermore, a number of the slim profile fluorescent lamps, which are connected in series, are used.

Description of the structure and the connection form of the slim profile fluorescent lamps will be omitted as it is described in detail in Korean Patent Registration No. 221195 (entitled “fluorescent lamp”) by the same inventor as the present invention.

Moreover, recently, the fluorescent lamps of a small diameter are used as an indirect illumination or ornamental illumination besides a direct illumination.

As shown in FIG. 2, the fluorescent lamp holder for mounting the fluorescent lamp includes a lamp holder 10 for mounting the fluorescent lamp 1, a circuit board for lighting up the fluorescent lamp 1, stabilizers and other necessary parts.

The fluorescent lamp 1 is seated on the lamp holder 10 by fitting connection terminals 2, which is mounted at both sides of the fluorescent lamp 1, to fixing members 11 of the lamp holder 10.

This method is the most well-known one for using the fluorescent lamp 1.

However, when the fluorescent lamp 1 is fit to the fixing members 11, to connect lots of fluorescent lamps 1, lots of lamp holders 10 are connected in series, and a space is formed between the fluorescent lamp 1 and the adjacent fluorescent lamp 1 at the connection part of the fluorescent lamps 1 by the fixing members 11 to which the connection terminals 2 of the fluorescent lamps 1 are fixed.

The fluorescent lamps 1 connected in series cannot provide a perfect illumination effect since such spaces cause break-off of illumination at the connection parts.

Meanwhile, to solve the above problem, there has been made an attempt to arrange the fluorescent lamp holders 10 in a zigzag form by overlapping the connection parts, but in this case, illumination is distorted since the fluorescent lamps 1 are not arranged in a straight line.

### SUMMARY OF THE INVENTION

Accordingly, the present invention has been made in view of the above problem, and it is an object to provide a fluorescent lamp, which can improve the outward appearance and an illumination effect by arranging fluorescent lamp holders in series regularly and removing gaps between the fluorescent lamps mounted to the fluorescent lamp holders.

To achieve the above object, according to the present invention, there is provided a fluorescent lamp including: a tubular lamp body; auxiliary tubes extending from both side ends of the tubular lamp body; and connection terminals formed inwardly at both side ends of the auxiliary tubes.

The fluorescent lamp further includes a fluorescent lamp holder located between the auxiliary tubes, the fluorescent lamp holder having lighting means mounted therein for lighting up and fixing members formed at both ends thereof for fixing the connection terminals of the lamp body.

### BRIEF DESCRIPTION OF DRAWINGS

Further objects and advantages of the invention can be more fully understood from the following detailed description taken in conjunction with the accompanying drawings in which:

FIG. 1 is a view of a conventional fluorescent lamp;

FIG. 2 is a view showing a state in which the conventional fluorescent lamps are connected and installed in series;

FIG. 3 is a view of a fluorescent lamp according to a preferred embodiment of the present invention;

FIG. 4 is a view showing a state in which the fluorescent lamps according to the present invention are connected and installed in series; and

FIG. 5 is a view of a fluorescent lamp according to another preferred embodiment of the present invention.

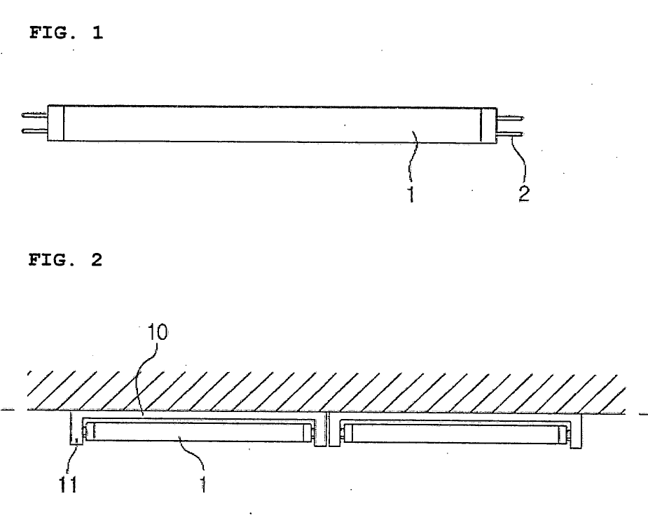

### DETAILED DESCRIPTION OF THE PREFERRED EMBODIMENT

The present invention will now be described in detail in connection with preferred embodiments with reference to the accompanying drawings.

The same parts as the prior art will not be described.

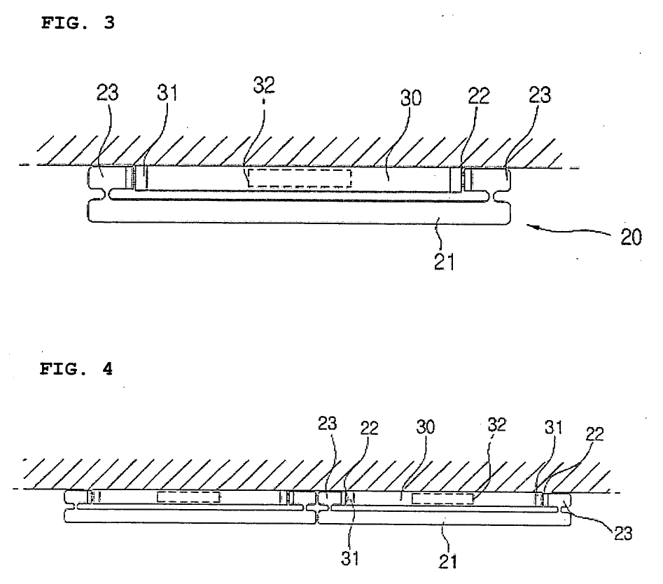

FIG. 3 is a view of a fluorescent lamp according to a preferred embodiment of the present invention, and FIG. 4 is a view showing a state in which the fluorescent lamps according to the present invention are connected and installed in series.

The most basic structure of a fluorescent lamp 20 according to the present invention is that a number of the fluorescent lamps 20 are closely arranged not to generate spaces between the fluorescent lamps 20 when the fluorescent lamps 20 are connected in series.

Additionally, it is important that even though the structure of the fluorescent lamps 20 is changed, the entire volume of the fluorescent lamps 20 is not increased after assembly of the fluorescent lamps 20 with fluorescent lamp holders 30.

To this end, the fluorescent lamp 20 includes a tubular lamp body 21 of a predetermined length, and auxiliary tubes 23 communicating with and extending from both side ends of the lamp body 21.

Here, it is preferable that the auxiliary tubes 23 do not protrude more than the ends of the lamp body 21 and extend to a predetermined length in the inward direction.

The fluorescent lamp 20 further includes connection terminals 22 formed inwardly at both side ends of the auxiliary tubes 23.

Therefore, the body 21 and the auxiliary tubes 23 of the fluorescent lamp 20 interlock with each other, and the auxiliary tubes 23 protrude from the body 21 of the fluorescent lamp 20.

The fluorescent lamp 20 according to the present invention is changed in the entire form in comparison with the conventional fluorescent lamps, but has the same functions as the conventional fluorescent lamps in aspects of utilization or technology.

As the fluorescent lamp 20 of the present invention has the both ends of a glass tube type as they are, even though a number of the fluorescent lamps 20 are arranged in series, any space is not formed between the fluorescent lamps 20.

The fluorescent lamps 20 arranged as the above are connected and installed on the fluorescent lamp holders 30 to light up.

The fluorescent lamp holder 30 is located between the auxiliary tubes 23, which is separated at a predetermined interval from each other, and has a lighting part 32 for lighting up.

Here, the lighting part 32 has several parts, such as a circuit board, a stabilizer, and so on.

Moreover, the fluorescent lamp holder 30 includes fixing members 31 formed at both ends thereof for fixing the connection terminals 22 of the auxiliary tubes 23.

Meanwhile, it will be appreciated that the fluorescent lamp holder 30 can be selected from fluorescent lamp holders of various types.

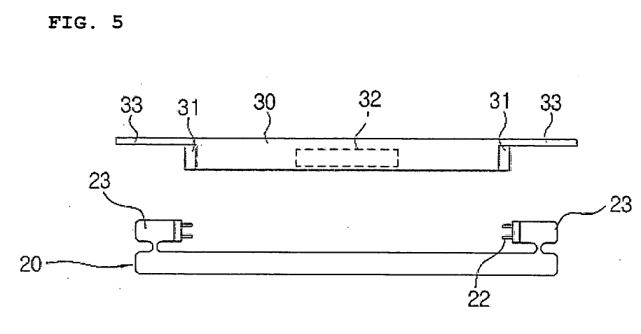

FIG. 5 shows a fluorescent lamp according to another preferred embodiment of the present invention. As shown in the drawing, the fluorescent lamp holder 30 has wing fragments 33 extending outwardly from both side ends thereof for preventing damage of the auxiliary tubes 23.

As described above, in the fluorescent lamp 20 according to the present invention, the auxiliary tubes 23 protrude from the fluorescent lamp, but the entire width and height of the fluorescent lamps 20 after assembly of the fluorescent lamps 20 are equal to those of the conventional fluorescent lamps.

Additionally, the above form and structure of the fluorescent lamp 20 according to the present invention can be changed in various types.

As can be seen in another preferred embodiment of the present invention, the structure of the fluorescent lamp 20 according to the present invention is not restricted to the fluorescent lamp 20, but may be applied to neon lamps or others in the same way.

Conventional neon lamps are manufactured not in a package type but separately in a desired shape. However, when the basic structure of the present invention is applied to the neon lamps, if the neon lamps and neon lamp holders for lighting up the neon lamps are combined in a package type, users can easily use neon lamps of various colors.

The neon lamps can be effectively used in cold regions, where common fluorescent lamps cannot be used, and can be simply used like fluorescent lamps of various colors.

Of course, the neon lamp holders for lighting up the neon lamps must include suitable parts, such as a stabilizer, a circuit board, and so on.

As described above, the fluorescent lamps according to the present invention can prevent break-off of illumination at the connection parts thereof and provide a beautiful appearance and a good illumination effect even when the fluorescent lamps are arranged in series.

Furthermore, if the neon lamps of the same structure as the fluorescent lamp and neon lamp holders for lighting up the neon lamps are combined in a package type, the present invention can provide various illumination effects and an advertising effect.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A fluorescent lamp comprising:
a tubular lamp body (21);
auxiliary tubes (23) extending from both side ends of the tubular lamp body (21); and
connection terminals (22) formed inwardly at both side ends of the auxiliary tubes (23).

2. The fluorescent lamp according to claim 1, further comprising a fluorescent lamp holder (30) located between the auxiliary tubes (23), the fluorescent lamp holder (30) having lighting means mounted therein for lighting up and fixing members (31) formed at both ends thereof for fixing the connection terminals (22) of the lamp body (21).

3. The fluorescent lamp according to claim 2, wherein the fluorescent lamp holder (30) has wing fragments (33) extending outwardly from both side ends thereof for protecting the auxiliary tubes (23) of the lamp body (21).
